(19) United States
(12) Patent Application Publication
(10) Pub. No.: US 2012/0085063 A1
(43) Pub. Date: Apr. 12, 2012

(54) FLASHING TAPE

(76) Inventor: Joseph Pufahl, Cutchogue, NY (US)

(21) Appl. No.: 13/328,235

(22) Filed: Dec. 16, 2011

Related U.S. Application Data
(63) Continuation-in-part of application No. 11/818,284, filed on Jun. 14, 2007.

(51) Int. Cl. E04B 1/68; B32B 7/10; B32B 7/00

(52) U.S. Cl. 52/741.4; 428/141; 428/41.8

(57) ABSTRACT

A flashing tape includes a moisture-impervious nonporous first layer having a drainage plane surface for providing drainage of moisture, the drainage plane surface being textured with embossed or otherwise raised spaced apart projections, the spaces between the projections, in conjunction with an overlay of construction material, defining a nondirectional flow path to permit the drainage of moisture and flow of air along said surface; a moisture-impervious second layer of closed cell polymeric foam which is bonded on a first side to the moisture-impervious first layer; and, a layer of pressure sensitive acrylic based adhesive applied to a second side of the moisture-impervious layer.

### CROSS REFERENCE TO RELATED APPLICATIONS

The present application is a continuation in part of U.S. application Ser. No. 11/818,284 filed Jun. 14, 2007, to which priority is claimed and which is herein incorporated by reference in its entirety.

### BACKGROUND

1. Field of the Invention

The present application relates to building construction, and particularly to a material and method for providing a flashing system for protecting buildings and other structures from moisture.

2. Background of the Art

Prevention of water damage is an ongoing task of the building construction industry. In particular, exterior moisture such as rain, when in long term contact with the interior structure of a building, can cause rotting of wood and growth of mold. The rotting of wood leads to structural damage and very expensive repairs. Molds can harm the health of the occupants of the building by causing allergies and other ailments.

Entry of moisture can occur over time by a combination of several mechanisms. For example, after several years buildings can settle. Their shapes become distorted and no longer square or level. Window joints and sealants can separate and openings can then develop in the flashing. Wind driven rain moving at an angle off vertical can seep in through the sides of the flashing.

Today the entire residential and commercial construction marketplace is threatened by the runaway costs of litigation and claims management due to the effects of mold and water damage to parts of the building envelope affected by the use of the present state of the art in flashing systems. Organizations like AAMA are attempting to develop minimum standards for self adhering flashing and are focused on the present generation of design ignoring the need for an adequate drainage plane at the critical building/opening interface.

To prevent water damage the construction industry uses weather resistant barriers (WRB) or housewraps which are impervious to water. Such moisture barriers include polymeric sheets (e.g., TYVEK™ brand polyolefin sheet), asphalt saturated felt or paper, and the like. Weather resistant barriers (WRB) or housewraps are used to cover broad sides of a building, but must also be used in addition to flashing tapes. Unlike weather resistant barriers (WRB) or housewraps, flashing tape is applied to the joints between around portals such as windows, doors, and skylights to prevent water seepage through the joint between the portal frame and the wall in which it is installed. Flashing tape has a different function than weather resistant barrier (WRB) or housewrap and requires a different construction with different materials. Flashing can include sheets of metal, polymer films, coatings of butyl, bitumen, silicone and other sealants, face films and other materials well known in the construction art. The problem with conventional flashing materials and methods is that once water does enter behind trim and cladding it has no easy way to drain or escape. The lack of a drainage plane at the critical building interface and in the flashing materials then becomes a disadvantage by trapping moisture between the flashing tape and the exterior trim, cladding and siding.

The existing flashing systems employ a mass of heavy, yet pliable, mastic material to block water and conform to uneven surfaces. The typical chemical structure limits the range of temperature performance and installation. They commonly experience compatibility problems with sealants used around the window and door openings used to seal gaps and seal the window in place. These products in their use of all impermeable materials and solid face films fail to create a drainage plane for water to migrate down the edges of the window away from the door or critical building interface and fail to introduce air to aid in evaporation. Moreover commonly used sealants often do not provide acceptable performance over a wide range of ambient temperature and moisture conditions over the life cycle of the windows, doors, etc. Under extreme weather conditions such as very high or very low temperatures, commonly used moisture barrier materials often separate from the substrate surface to which they are attached, leaving gaps through which moisture can enter to cause damage to the underlying structure.

What is needed, and what the present invention provides, is a moisture barrier material providing water impermeability, drainage of moisture and air flow on its external surface, pliability, conformance to structural surface variations, sealant compatibility, and excellent immediate and long term adhesion to common building substrates, for example, in the immediate proximity of the window, door, or joint at the most vulnerable part of the building.

### SUMMARY

Provided herein is a flashing tape which comprises (a) a moisture-impervious nonporous first layer having a drainage plane surface for providing drainage of moisture, the drainage plane surface being textured with embossed or otherwise raised spaced apart projections, wherein said first layer is configured so that when an overlay of construction material is abutted against said surface a nondirectional flow path is provided to permit the flow of air and water along said surface through a defined space between the construction material and the moisture impervious first layer; (b) optionally a moisture-impervious second layer of cross linked closed cell polymeric foam which is bonded on a first side to the moisture-impervious first layer; and, (c) a layer of pressure sensitive acrylic or similarly performing adhesive applied to a second side of the moisture-impervious layer. That is, the flashing tape system possesses sufficient sealant compatibility as determined by the AAMA 713-08, Voluntary Test Method to Determine Chemical Compatibility of Sealants and Self-Adhered Flexible Flashings. Products also must meet or exceed the performance and test requirements of AAMA 711-07 Voluntary Specification for Self Adhering Flashing Used for Installation of Exterior Wall Fenestration Products

The flashing tape is particularly useful for installing a portal such as a window or door in an opening in a wall, or for sealing joints in roofs, for installing skylights, weather stripping, deck installation, and similar such uses. It can also be used as a house wrapping moisture barrier, WRB, over broad expanses of walls, roofs, flooring and the like.

### BRIEF DESCRIPTION OF THE DRAWINGS

Various embodiments are described below with reference to the drawings wherein:

FIG. 1 is a perspective view of an embodiment of the flashing material of the invention;

FIGS. 1A, 1B and 1C are alternative embodiments of the flashing material;

FIG. 2 is a front elevational view illustrating the use of the flashing material for sealing the periphery of a window;

FIG. 3 is a side elevational view illustrating an alternative use of the flashing tape of the invention in connection with a window sill

FIG. 4 is a front elevational view illustrating the use of the flashing tape for sealing the periphery of a window;

FIG. 5 is an exploded perspective view illustrating the use of the flashing tape for sealing the periphery of a window;

FIG. 6 is a perspective view illustrating the flashing tape of the invention;

FIGS. 7 and 7A are sectional views illustrating top layer(s) of the flashing tape;

FIGS. 8 and 8A are diagrammatic side views showing embodiments of the flashing tape of the invention adhered to a wall and providing a drainage plane in conjunction with siding adjacent thereto; and,

FIG. 9 is a diagrammatic illustration of the use of the invention in conjunction with flooring.

### DETAILED DESCRIPTION OF PREFERRED EMBODIMENT(S)

Other than in the working examples or where otherwise indicated, all numbers expressing amounts of materials, reaction conditions, time durations, quantified properties of materials, and so forth, stated in the specification and claims are to be understood as being modified in all instances by the term “about.”

It will also be understood that any numerical range recited herein is intended to include all sub-ranges within that range.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

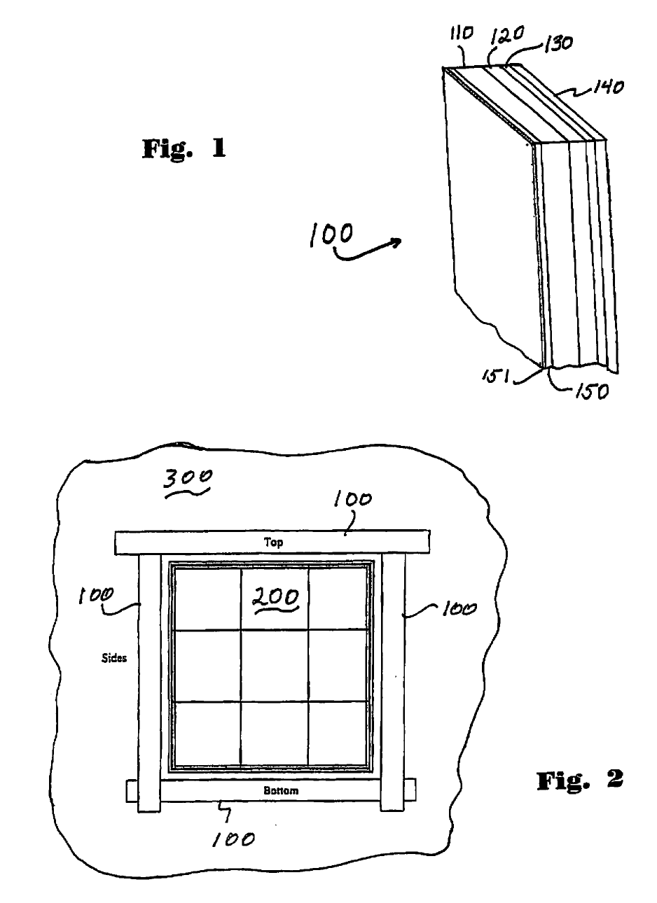

Referring now to FIG. 1, in one embodiment the flashing material of the invention, i.e., flashing tape 100 includes a first layer of porous polymeric sheet 110 capable of permitting the passage of water therethrough along the plane of the sheet so as to provide a drainage plane for water. Preferably the porous polymeric sheet 110 is an open cell foam. A preferred open cell foam suitable for use in the invention is available from Foamex International Inc. of Linwood, Pa. under the designations 2AZUF and P4B. Alternatively, the porous polymeric sheet 110 can comprise a woven or non-woven fibrous layer. A second layer 120 of polymeric sheet is bonded to the first layer 110, for example by flame bonding or adhesive bonding or any other suitable bonding method. Second layer 120 is impervious to moisture (water or water vapor) and is preferably a closed cell polymeric foam. A closed cell polymeric foam suitable for use in the invention is available from Sekisui Voltek LLC under the designation Volara 3TS, 5TS, EO or G. Alternatively, second layer 120 can be a moisture impermeable sheet such as polymeric film or metal foil.

The flashing tape 100 of the invention preferably further includes a layer of 130 of adhesive applied to a second side of the second layer 120. The adhesive is preferably a high performance pressure sensitive acrylic based adhesive or other similarly performing adhesive which passes the AAMA 713-08, Voluntary Test Method to Determine Chemical Compatibility of Sealants and Self-Adhered Flexible Flashings and meets or exceeds the performance and test requirements of AAMA 711-07 Voluntary Specification for Self Adhering Flashing Used for Installation of Exterior Wall Fenestration Products to facilitate adherence to a substrate such as a wall, window fins, plywood, OSB, or sheet of flashing or house wrapping material. A pressure sensitive adhesive suitable for use in the present invention is available in a 1-sided or 2-sided coated VOLTEK Volara STS foam from Adchem Co. under the designation MTLG-190. Preferably the flashing tape 100 includes a release film 140 which is removed prior to application of the tape 100 to a substrate.

Optionally, the flashing tape 100 can further include another pressure sensitive adhesive layer 150, as well as an associated removable release liner 151 overlying the adhesive layer 150, on an upper surface of the open cell foam first layer to permit adhesion of a layer of water resistant flashing or house wrapping material on top of the flashing tape 100. The house wrapping material can be a sheet of polyolefin film, preferably spun-bonded polyethylene or spun-bonded polypropylene (e.g., TYVEK® brand), metal or foil sheet or other conventional material. A preferred house wrapping material for use in conjunction with the flashing tape of the invention is a spun-bonded or non spun-bonded polyolefin sheet housewrap WRB having at least one engineered surface textured with embossed nondirectional channels. In an embodiment, water drainage is permitted only along said engineered surface. In an embodiment a polyolefin sheet useful in the invention and which is commercially available from Valeron Films under the designation VORTEC™.

Referring now to FIGS. 1A and 1B, a flashing arrangement employing flashing tape 100A includes the porous polymeric sheet 110 bonded to the water-impermeable second layer 120, which has an adhesive layer 130. A water resistant house wrap 160 can be applied to the flashing tape 100A and bonded to the porous sheet 110. The house wrap has at least one textured surface 161 with embossed nondirectional channels, which provide a drainage plane along the surface 161 to permit the drainage of moisture. Thus, drainage is provided by both the porous polymeric sheet 110 and the textured surface 161 of the house wrap. Embodiment 100A of the flashing tape can also include a release liner 140 adjacent to adhesive layer 130 and an additional adhesive layer 150 on the opposite side of the flashing tape 100A with second release liner 151 as illustrated in FIG. 1.

FIG. 1B illustrates the house wrap 160 bonded directly to the water impermeable second layer 120 of flashing tape 100B such that the drainage plane is provided by the textured surface 161 of the house wrap.

FIG. 1C illustrates an embodiment in which a spun-bonded or non spun-bonded polyolefin sheet 160 having an embossed textured surface 161 is bonded to a moisture impervious layer 120 such as a closed cell polymeric foam layer. A layer 130 of pressure sensitive adhesive is disposed on a surface of the closed cell polymeric foam opposite to that on which the polyolefin sheet 160 is bonded. The embossed textured surface 161 is on a side of the polyolefin sheet 160 opposite to that on which the closed cell polymeric foam is bonded. In an alternative embodiment an open cell foam 110 can be substituted for the closed cell polymeric foam 120 in flashing tape 100C.

The flashing tape 100 of the invention is typically about 4 to 9 inches wide and stored in rolls. The preferred thickness ranges from about 0.020 inches to about 0.080 inches. It should be flexible, but not so compressible as to collapse the open cell foam under normal pressures, which would interfere with the functioning of the drainage plane provided by the tape 100. Any dimensions suitable for the use described herein can be used.

Optionally, the first or second polymeric layers 110 and/or 120 can have one or more agents incorporated therein such as, for example, agents for inhibiting the growth of mold or mildew, as well as insecticides, antimicrobials and/or other biocides, as well as fire retardants. The pesticide can be incorporated into the polymer itself or can be introduced into the open cell foam after fabrication. Compatible organic and inorganic pesticides for protecting against damage by mildew, fungi, mold, termites and other wood eating insects are known as well as flame retardants.

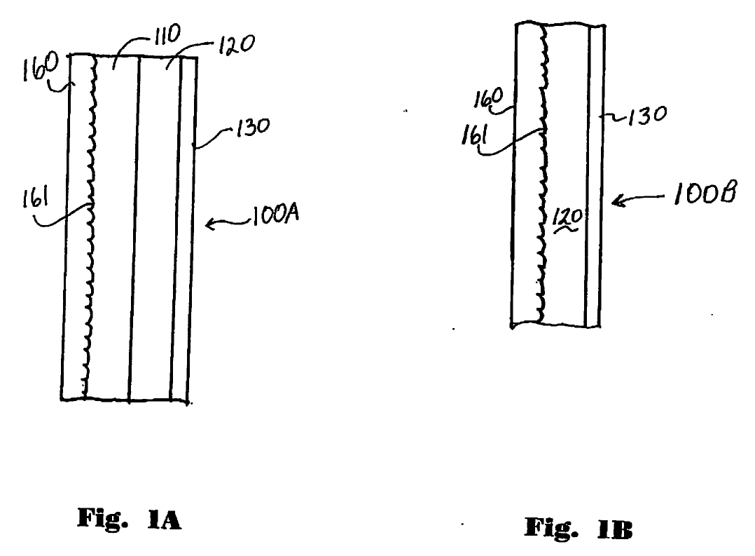

Referring now to FIG. 2, use of the flashing tape 100 is illustrated wherein window 200 is mounted into an appropriately sized opening in wall 300 of a building. In a typical window installation procedure the house wrap is applied to the sides and bottom of an opening in the wall into which the window is to be installed. The window is then inserted. Appropriate sealants (e.g., silicones, urethanes, acrylics, or other suitable compounds) can be used to fill the gap in the joint between the window and wall to secure the window. Typically, the new window installation will have a flange extending one or two inches further than the edge of the opening. The window is sealed to the structure with commercial sealants under the flange and for replacement windows at the joint of the replacement window frame and the rough opening or old window frame. The flange can be secured to the structure with fasteners (nails, screws, etc.). In one procedure the flashing tape 100 is applied over the flange and the wall so as to overlap the edge of the flange. Optionally, the flashing tape 100 can be applied around the periphery of the opening in accordance with recognized installation procedures available from AAMA, AIA, WDMA and ASTM prior to installation of the replacement window so as to provide a drainage plane. Other flashing material, house wrap, etc. or trim boards can be applied over the flashing tape 100.

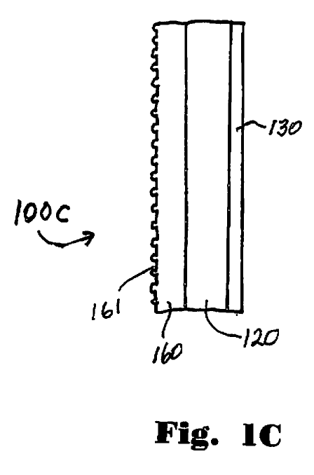

In an alternative embodiment as shown in FIG. 3, a sloped piece 210, preferably fabricated from a composite wood or plastic, is mounted on the sill between wall 300 and window 200. A low permeability film 170 of, for example, polyethylene of EPDM membrane, is adhesively bonded to the top of the sloped piece 210 and arranged to wrap around the corner of the sill and overlap the water resistant house wrap 165 mounted to the exterior surface of the wall 300. A porous polymeric sheet 115 fabricated from an open cell foam or fibrous sheet as described above in connection with layer 110 is mounted to film 170 to provide a drainage plane. An open cell foam, for example, will provide a barrier to air intrusion while allowing water to escape from the building structure. Preferably, house wrap 165 has at least one textured surface with embossed channels to provide a drainage plane, as described above with respect to VORTEC™ brand house wrap.

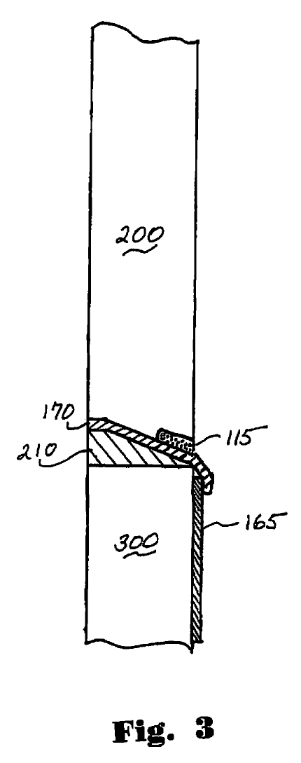

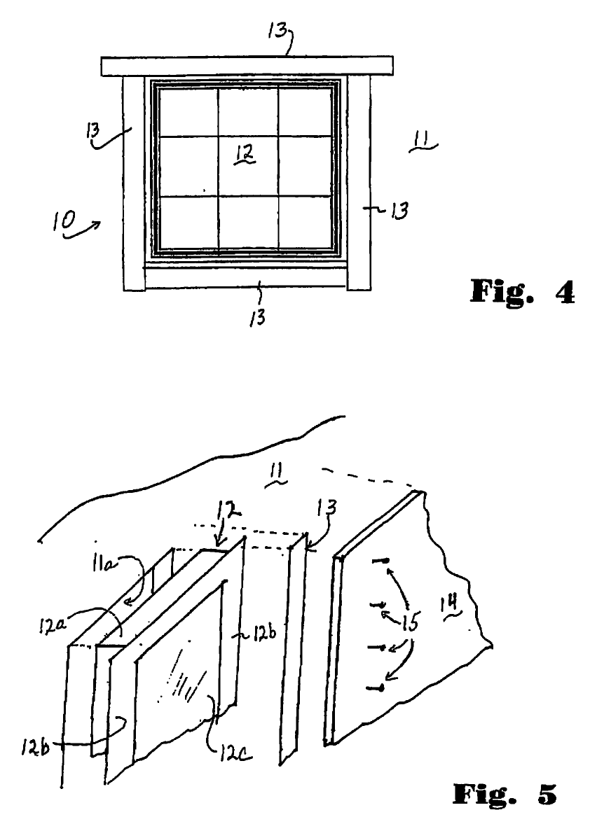

In another and more preferred embodiment of the invention, and referring now to FIGS. 4 and 5, a standard lay up 10 for installation of a window fixture into the side of a building is illustrated. Window fixture 12 includes a pane 12c secured within a frame 12a having a flange 12b. An opening 11 a is cut into wall 11 of the building to accommodate engagement of the window frame 12a therein. Typically a layer of weather resistant barrier (WRB) or housewrap is disposed over the wall. Weather resistant barrier (WRB) or housewrap, such as spun bonded polyolefin film (e.g., TYVEK®) allows water vapor to pass through, but not water. A preferred house wrapping material for use in conjunction with the flashing tape of the invention is a spun-bonded or non spun-bonded polyolefin sheet house wrap having at least one engineered surface textured with vertical channels or, alternatively, nondirectional channels for permitting aeration and water drainage only along said surface. A suitable nondirectional material is commercially available from Valeron Films under the designation VORTEC™. A suitable vertically directional weather resistant barrier (WRB) or housewrap is available from Green Guard Co. under the designation Rain Drop®. Thus, it provides breathability in conjunction with protection against rain or other external sources of water. Once properly seated and secured with a waterproof sealant around the edges of the frame 12a, a flashing tape 13 is disposed over the joint formed by the edge of the flange 12b and the surface of the wall 11. The tape 13 is disposed over the top, bottom and sides of the window 12, as shown in FIG. 4. Wall siding 14 (wood, aluminum, polyvinyl chloride, etc.) in sheet form is then secured to the wall 11 and overlays the flashing tape 13. Siding 14 is secured to the wall 11 typically by nails 15, as shown in FIG. 5.

A problem with conventional flashing tapes is that they do not provide a true drainage plane, or flow path for moisture and air, under actual working conditions. For example, insertion of the nail fasteners compresses the tape and flattens its surface. After weather cycles of hot and cold, the nails tend to pull away from the wall due to expansion and contraction. This forms pockets which tend to fill with water which does not drain properly, thereby causing water damage such as rotting and mildew.

Although conventional flashing tapes provide a seal against moisture, they do not provide an adequate means to drain water. Also, various other water drainage materials such as open wire forms used in construction and roofing are too rigid and impractical for use in building trim and cladding. The present invention provides a true drainage plane, or flow path, for moisture. A drainage plane is an avenue for the drainage flow of water under environmental conditions. The flashing tape of the invention, in conjunction with an overlay of construction material such as siding, cladding, etc., provides a capillary break and a water drainage rate of at least 16 oz. per hour and preferably at least 32 oz. per hour per inch of width under environmental conditions with cladding or trim fastened thereto. Generally, at least a 4 inch wide flashing tape is preferred for the drainage of at least about 2 or more gallons per hour.

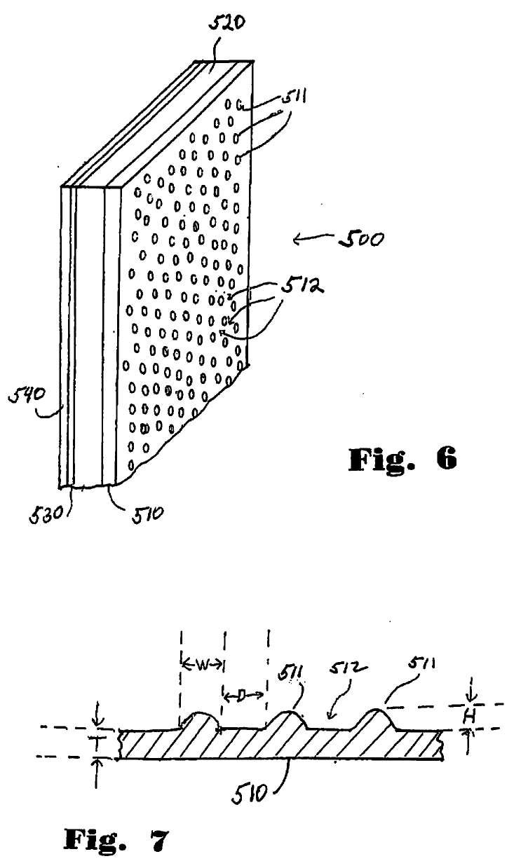

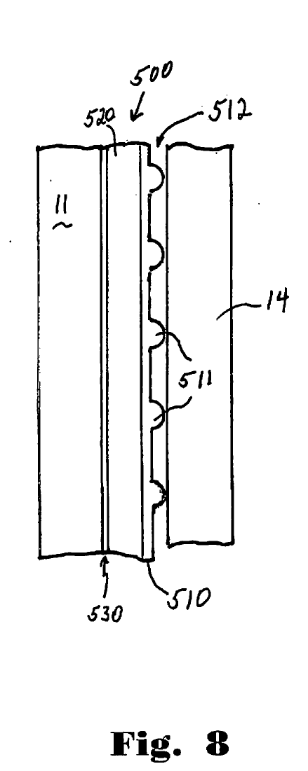

Referring now to FIGS. 6, 7 and 7A the flashing tape of the invention is a flexible and conformable self-adhering tape which both seals against moisture and provides a capillary break and nondirectional flow path for the drainage of moisture and air. The flashing tape 500 is intended for sealing the joints around windows, doors, skylights, vents and other openings of the building envelope. Typically, it is provided in rolls of 4 to 12 inch widths, although other widths and shapes are within the purview of this invention.

The flashing tape 500 comprises a solid, non-porous, first moisture impervious layer 510 with an outer surface providing, in combination with an adjacent trim or exterior cladding or siding, a non-directional flow path along which water and air can easily flow through or run off. The moisture impervious layer 510 can be fabricated from, for example, a metal foil such as aluminum foil, but is preferably fabricated from a flexible polymer film which is preferably bonded to a second moisture-impervious layer 520 of flexible closed cell cross-linked foam, preferably of the same polymer. Optionally, the polymer foam can be omitted from the flashing tape construction. An adhesive layer 530 is disposed on the side of the closed cell foam of the second moisture impervious layer 520 opposite to that to which the moisture impervious layer 510 is bonded. Finally, a release liner 540 is disposed over the adhesive 530. In an embodiment, the release liner 540 is made of recyclable material. In another embodiment the adhesive can be applied to the moisture impervious layer 510 without the second moisture impervious layer 520.

Moisture impervious layer 510 is preferably fabricated from a polyolefin, polyvinyl chloride, polyurethane, or other polymer suitable for the purposes described.

Preferably, the moisture impervious layer 510 is sufficiently hydrophobic as to cause moisture to bead on its surface. A preferred polymer for fabricating water impervious layer 510 is polyethylene, such as high density polyethylene (HDPE), and linear low density polyethylene (LLDPE). Moisture impervious layer 510 (and/or moisture impervious layer 520) can optionally include additives such as plasticizers, colorants, fillers, mold and mildew inhibitors, agents to prevent damage from UV radiation, insecticides and other additives to withstand the adversities of environmental conditions. Various additives such as listed above are known in the art and are commercially available. In a preferred embodiment moisture impervious layer 510 is fabricated from high density polyethylene (HDPE). A preferred polymeric film material suitable for use in the invention is available from Sekisui Voltek of Coldwater Mich.

Referring specifically now to FIGS. 7 and 7A, moisture impervious layer 510 includes on an exterior surface a plurality of projections 511, embossed or otherwise raised, to provide, in combination with an adjacent trim, cladding, siding, or other construction panel, a nondirectional flow path 512 to facilitate the drainage of water and/or air along said surface. Capillary forces can prevent the free flow of fluid through the drainage plane. Accordingly, the configuration, spacing between projections and height of the projections are of sufficient dimensions to provide a capillary break to overcome capillary forces which would prevent the free flow of water and air through the flow path 512. The projections 511 preferably have an arcuate upper surface, but can alternatively be configured as rods, pyramids, or any other shape suitable for the purposes described herein. The projections 511 are spaced apart and the spaces between the projections define a nondirectional flow path 512 for moisture. The thickness T of moisture impervious layer 510 can typically range from about 0.003 inches to about 0.010 inches, although thickness outside of this range can also be used whenever appropriate. The projections 511 have a height H of at least 0.009 inches to provide a capillary break, but preferably at least about 0.010 inches, and preferably range in height H of from 0.010 to 0.015 inches. The width W of the projections and the distance D between the projections is preferably at least about 0.02 inches and typically can range from about 0.02 to about 0.20 inches or more, although a preferred range is from about 0.06 to about 0.07 inches. The ranges given above are for illustrative purposes. Values for H, D, W and T outside the scope of the given ranges are also within the scope of the invention. Moisture impervious layer 510 is flexible but not elastically stretchable and of such stiffness that the projections 511 will substantially maintain their height H (i.e., undergo no significant flattening), and thus continue to provide a capillary break and the flow path 512, for moisture and air even under the forces of compression typically encountered when siding is fastened thereover.

Moisture impervious layer 520 is, as indicated above, a flexible layer of cross-linked, closed-cell polymeric foam, preferably of the same polymer as that of layer 510. Many foams incorporating EVA (ethylene vinyl acetate), or PET, (polyethylene terephthalate) may also be suitable. A suitable foam layer 520 comprises a cross linked polyethylene (XLPE) foam having a density of about 3.5 lbs/ft³. The composite of film and foam has a tensile strength of about 654, an elongation percent of about 641, a tear resistance of about 109 psi and a compression deflection of about 6 at 25%. Moisture impervious layer 520 is conformable to the surface onto which the flashing tape is applied and provides a water impervious barrier. Typically, moisture impervious layer 520 can range in thickness from about 0.02 to 0.10 inches, although values of thickness outside of this range can be used when appropriate and are also within the scope of this invention. A preferred uncompressed thickness for layer 520 ranges from about 0.02 to 0.07 inches, which is suitable for most residential home construction. A preferred closed cell foam for moisture impervious layer 520 suitable for use in the invention is available from Sekisui Voltek of Coldwater Mich.

In an embodiment, the first moisture impervious layer 510 can be first fabricated with hollow projections or solid projections as shown in FIG. 7. This layer can then be bonded to the polymeric foam layer 520 by, for example, flame bonding or adhesive bonding. However, co-extrusion of film layer 510 and foam layer 520 of the same polymer provides an optimal bond between these two layers. Referring to FIG. 7A, fabrication of the bonded layers 510 and 520 by coextrusion typically involves depositing a layer of fluid polymer for layer 510 onto an extruded layer 520 of foamed polymer. Before final curing and hardening, an embossing apparatus compresses the foam in the region 512 between the projections 511 and forms the projections 511 onto the upper surface of the layer 510 with foam filling the hollows in the projections as shown. In the final product, moisture impervious layers 510 and 520 are directly bonded to each other by molecular commingling of the polymers at the adjacent surfaces to provide an integral structure.

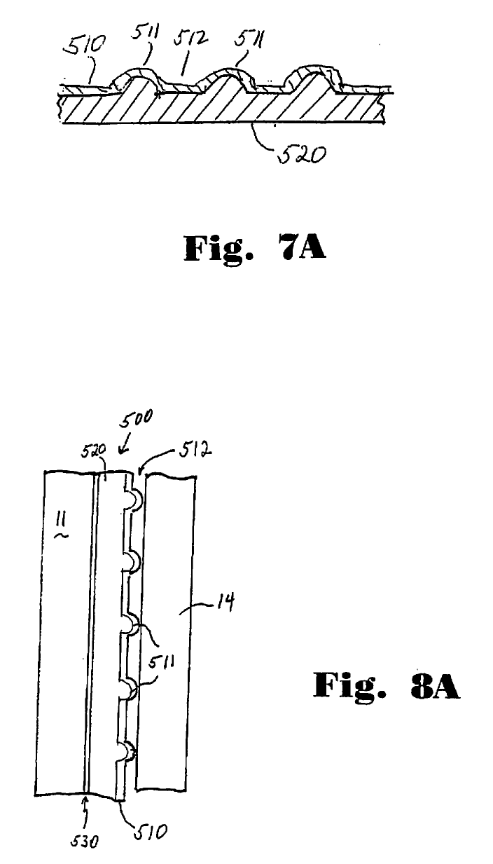

FIGS. 8 and 8A are a side view of the flashing tape of FIG. 6 adhered to a wall and in conjunction with an adjacent siding. In particular, flashing tape 500 including a moisture impervious layer 510 having projections 511, a moisture impervious, cross-linked closed cell moisture impervious foam layer 520 and an adhesive layer 530. The flashing tape 500 is bonded to the wall, or other substrate 11 by the adhesive layer 530. Siding, cladding, trim or other construction panel 14 abuts the surface of the moisture impervious layer 510 with the projections 511 acting as spacers to provide flow path 512 between the moisture impervious layer 510 and the construction panel 14. FIG. 8 illustrates the embodiment of FIG. 7, and FIG. 8A illustrates the embodiment of FIG. 7A as described above.

A layer 530 of adhesive is disposed on the opposite side of foam layer 520, and a removable release line 540 is disposed over the adhesive. In an embodiment the adhesive layer 530 typically ranges in thickness of from about 0.002 to about 0.008 inches and the release liner 540 typically ranges in thickness from about 0.002 to about 0.007 inches. The release liner can be, for example, high density polyethylene, paper, or other suitable material. In use, the release liner is removed and the adhesive side of the tape is pressed onto the construction surface with the upper surface of moisture impervious layer 510 facing outward to provide the flow path 512. In an embodiment, a layer of adhesive can be disposed on at least a portion of the drainage plane surface of moisture impervious layer 510 to facilitate adhering to itself of siding or other construction material thereupon.

The adhesive 530 can be any adhesive suitable for the purposes described herein, such as, for example butyl rubber adhesive. However, butyl rubber adhesive has several drawbacks in that it loses tackiness in cold weather and becomes unmanageably sticky in hot weather. A preferred adhesive for use in the present invention is an acrylic based adhesive. More particularly, the adhesive is preferably a high performance pressure sensitive acrylic based adhesive to facilitate adherence to all typical construction materials such as a wall or sheet of flashing or house wrapping material. The adhesives have to be capable bonding onto rough surfaces at low and high temperatures not only to the polyethylene they have to bond to house wraps, OSB, plywood, metals, vinyl as surfaces in the building envelope involved in the construction of residential homes. Further, the acrylic based adhesives are generally far more tolerant than butyl, asphaltic and bituminous adhesives to the sealants used in the trades. The selected adhesives have passed the AAMA 713-08 voluntary test method to determine chemical compatibility of sealants and self adhered flexible flashings and demonstrate compatibility with 16 different types of sealants including urethane, silicone, butyl, acrylic, vinyl and several blended systems. This compatibility surpasses most of the products in the market and helps builders and designers to have far greater range of selected sealants for use in window and door installations. Additionally, the caliper of the adhesive must be controlled to provide adhesion to the porous and uneven surfaces while maintaining decades of water resistance and, finally, nail sealability. A pressure sensitive adhesive suitable for use in the present invention is available in a transfer or unsupported tape or film from Adchem Corp. under the designation 7854.

The flashing tape of the invention has the following properties as set forth in Table 1 below:

TABLE 1

| Properties | Range | |
|---|---|---|
| Tensile Strength Machine Direction per ASTM D 5034 at 73° F. and | 15-16 | lbs |
| 50% RH Minimum Value 2.9 lbs/inch | | |
| Water Penetration Resistance Around Nails per ASTM D 1970-01 | No water | |
| Sec 7.9 Procedure Minimum 31 mm(1.2 in) water | | |
| Peel Adhesion per ASTM D 3330, Method F, As Described in | | |
| Sections 4.6 and 16.0 of that Method | | |
| 24 hr dwell at 73° F./50% RH Minimum Peel Value 0.26 N/mm | 4-5 | lbs/linear inch |
| (1.5 lb/in) OSB | | |
| 24 hr dwell at 73° F./50% RH Minimum Peel Value 0.26 N/mm | 4-5 | lbs/linear inch |
| (1.5 lb/in) Plywood | | |
| 24 hr dwell at 73° F./50% RH Minimum Peel Value 0.26 N/mm | 4-5 | lbs/linear inch |
| (1.5 lb/in) Anodized Aluminum | | |
| 24 hr dwell at 73° F./50% RH Minimum Peel Value 0.26 N/mm | 5-8 | lbs/linear inch |
| (1.5 lb/in) Vinyl | | |
| 24 hr dwell at 73° F./50% RH Minimum Peel Value 0.26 N/mm | 4-6 | lbs/linear inch |
| (1.5 lb/in) House Wrap | | |
| Accelerated Aging with UV Exposure per ASTM D 154 Cycle 1 - | 6-8 | lbs/linear inch. |
| 336 hours test per ASTM D 3330 Method F | | |
| Minimum Peel Value 0.26 N/mm (1.5 lb/in) anodized Aluminum | | |
| Elevated Temperature Exposure Peel Adhesion per ASTM D 3330, | | |
| Method F and No Change in Appearance | | |
| 24 hr @ RT, followed by 7 Day dwell at 65° C. (149° F.). Minimum | 4-6 | lb/linear inch. |
| Peel Value 0.26 N/mm (1.5 lb/in) OSB | | |
| 24 hr @ RT, followed by 7 Day dwell at 65° C. (149° F.). Minimum | 3-5 | lb/linear inch. |
| Peel Value 0.26 N/mm (1.5 lb/in) Plywood | | |
| 24 hr @ RT, followed by 7 Day dwell at 65° C. (149° F.). Minimum | 4-6 | lbs/linear inch. |
| Peel Value 0.26 N/mm (1.5 lb/in) Anodized Aluminum | | |
| 24 hr @ RT, followed by 7 Day dwell at 65° C. (149° F.). Minimum | 3-5 | lb/linear inch. |
| Peel Value 0.26 N/mm (1.5 lb/in) OSB | | |
| 24 hr @ RT, followed by 7 Day dwell at 80° C. (176° F.). Minimum | 3-5 | lb/linear inch. |
| Peel Value 0.26 N/mm (1.5 lb/in) Plywood | | |
| 24 hr @ RT, followed by 7 Day dwell at 80° C. (176° F.). Minimum | 4-6 | lb/linear inch. |
| Peel Value 0.26 N/mm (1.5 lb/in) Anodized Aluminum | | |
| Thermal Cycling 50° C. 8 hours and −40° C. for 16 hours 10 cycles. | 5-7 | lb/linear inch. |
| Minimum Peel Value 0.25 N/mm (1.5 lb/in) Anodized Aluminum | | |
| test per ASTM 3330 Method F and No Change in Appearance | | |
| Cold temperature Pliability per ASTM D 1970 Modified to −29 ° C. | No Cracking | |
| (−20° F.) | | |
| Adhesion of Self Adhering Flashing After Water Immersion Peel | 3-5 | lb/linear Inch |
| Adhesion per AAMA 800 Sec 2.4.1.3.1/2.4.1.4.3 ASTM D 3330, | | |
| Method F Minimum Peel Value 0.26 N/mm | | |

| | |
|---|---|
| Resistance to Peeling From Itself per AAA 711-07 | No visual change in |
| | appearance or adhesion |

### EXAMPLE(S)

### Example 1

In accordance with a modified ASTM E2273-03 test method the flashing tape of the present invention was tested for drainage rate of water shed off building trim and cladding and comes into contact with the flashing tape. The flashing tape is installed over a nailing fin. A clear polyacrylic plate is disposed over the flashing tape to simulate the installation of cladding and trim boards. The rate of drain is calculated by measuring the weight of water passing between the flashing tape and polyacrylic plate over a period of time. Table 1 below sets forth the drainage rate results for samples of the flashing tape of the invention and comparison tapes (which are not in accord with the invention). Each of the tape samples was four inches in width and of the same length.

The flashing tape of the invention identified in Table 2 as Tape #1, included a 10 mil thick nonporous polyethylene face sheet coextruded with a cross linked closed cell polyethylene foam. The polyethylene face sheet had an embossed surface as described hereinabove. Tape #1 had high performance acrylic based adhesive.

Comparative Tape A, not in accordance with the invention, was a 25 mil thick film of cross laminated high density polyethylene having a layer of butyl adhesive. The surface was smooth, without embossed projections. Comparative Tape A is commercially available from W.R. Grace Company under the designation Vycor®.

Comparative Tape B, not in accordance with the invention, was a 70 mil thick layer of elasticized polyethylene laminate (TYVEK® brand) with a layer of butyl adhesive. This surface was smooth, without embossed projections. Comparative Tape B is commercially available from DuPont company under the designation FlexWrap™.

TABLE 2

| Tape | Drainage Rate |
|---|---|
| Tape #1 | 128 oz./hr |
| Comparative Type A | 3.8 oz/hr |
| Comparative Type B | 3 oz./hour |

The above results show a drainage rate for the flashing tape of the invention which exceeds 32 times the drainage rate of the comparative flashing tapes. The drainage of water of the comparative Tapes A and B was observed to be along the edges. With the polyacrylic plate pressed against the flat surfaces, there was substantially no significant drainage provided by the surfaces of the comparative flashing tapes under actual conditions of use. With a four inch width flashing tape providing a 128 oz./hr drainage, it is estimated that a drainage rate of 32 oz./hr per inch of width can be achieved for 4 inch width tapes. Accordingly, a 6 inch width tape can achieve a drainage rate of at least 192 oz./hr and a 9 inch tape can achieve a drainage rate of at least 288 oz/hr under environmental conditions with trim and/or cladding attached thereto.

Moreover, the flashing tape sample of the invention weighed only 58% of the corresponding sized sample of Comparative Type A. This is a significant advantage as rolls of the flashing tape of the invention weigh less for corresponding amounts of tape, are easier to store and result in easier handling by construction workers

### Example 2

Pursuant to AAMA 711-07 Voluntary Specification For Self Adhering Flashing Used For Installation Of Exterior Wall Fenestration Products the flashing tape of the invention was tested for adherence to minimum performance requirements. The specific methods and associated results are set forth below in Table 3.

TABLE 3

| AAMA | | | |
|---|---|---|---|
| 711-07 | Test Method and Minimum Requirements | Test Results | |
| 5.1 | Tensile Strength Machine Direction per ASTM | 15.4 | lbs |
| | D 5034 at 73° F. and 50% RH Minimum Value | | |
| | 2.9 lbs/inch | | |
| 5.2 | Water Penetration Resistance Around Nails per | No water found | |
| | ASTM D 1970-01 Sec 7.9 Procedure Minimum | | |
| | 31 mm(1.2 in) water | | |
| 5.3 | Peel Adhesion per ASTM D 3330, Method F, | | |
| | As Described in Sections 4.6 and 16.0 of that | | |
| | Method | | |
| 5.3.2 | 24 hr dwell at 73° F./50% RH Minimum Peel | 4.75 | lb/linear |
| | Value 0.26 N/mm (1.5 lb/in) OSB | inch | |
| 5.3.2 | 24 hr dwell at 73° F./50% RH Minimum Peel | 4.3 | lb/linear |
| | Value 0.26 N/mm (1.5 lb/in) Plywood | inch | |
| 5.3.2 | 24 hr dwell at 73° F./50% RH Minimum Peel | 4.4 | lb/linear |
| | Value 0.26 N/mm (1.5 lb/in) Anodized | inch | |
| | Aluminum | | |
| 5.3.2 | 24 hr dwell at 73° F./50% RH Minimum Peel | 6.21 | lb/linear |
| | Value 0.26 N/mm (1.5 lb/in) Vinyl | inch | |
| 5.3.2 | 24 hr dwell at 73° F./50% RH Minimum Peel | 4.91 | lb/linear |
| | Value 0.26 N/mm (1.5 lb/in) House Wrap | inch | |
| 5.4 | Accelerated Aging with UV Exposure per | 6.37 | lb/linear |
| | ASTM D 154 Cycle 1 - 336 hours test per | inch. No Change | |
| | ASTM D 3330 Method F Minimum Peel Value | in appearance | |
| | 0.26 N/mm (1.5 lb/in) anodized Aluminum | | |
| 5.5 | Elevated Temperature Exposure Peel Adhesion | | |
| | per ASTM D 3330, Method F and No Change | | |
| | in Appearance | | |
| 5.5.3 | 24 hr @ RT, followed by 7 Day dwell at 65° C. | 4.63 | lb/linear |
| Level 2 | (149° F.). Minimum Peel Value 0.26 N/mm | inch. No change | |
| | (1.5 lb/in) OSB | in appearance | |
| 5.5.3 | 24 hr @ RT, followed by 7 Day dwell at 65° C. | 3.3 | lb/linear |
| Level 2 | (149° F.). Minimum Peel Value 0.26 N/mm | inch. No change | |
| | (1.5 lb/in) Plywood | in appearance | |
| 5.5.3 | 24 hr @ RT, followed by 7 Day dwell at 65° C. | 5.07 | lb/linear |
| Level 2 | (149° F.). Minimum Peel Value 0.26 N/mm | inch. No change | |
| | (1.5 lb/in) Anodized Aluminum | in appearance | |
| 5.5.3 | 24 hr @ RT, followed by 7 Day dwell at 65° C. | 3.3 | lb/linear |
| Level 3 | (149° F.). Minimum Peel Value 0.26 N/mm | inch. No change | |
| | (1.5 lb/in) OSB | in appearance | |
| 5.5.3 | 24 hr @ RT, followed by 7 Day dwell at 80° C. | 3.5 | lb/linear |
| Level 3 | (176° F.). Minimum Peel Value 0.26 N/mm | inch. No change | |
| | (1.5 lb/in) Plywood | in appearance | |
| 5.5.3 | 24 hr @ RT, followed by 7 Day dwell at 80° C. | 5.05 | lb/linear |
| Level 3 | (176° F.). Minimum Peel Value 0.26 N/mm | inch. No change | |
| | (1.5 lb/in) Anodized Aluminum | in appearance | |
| 5.6 | Thermal Cycling 50°C. 8 hours and −40° C. | 6.1 | lb/linear |
| | for 16 hours 10 cycles. Minimum Peel Value | inch. No change | |
| | 0.25 N/mm (1.5 lb/in) Anodized Aluminum | in appearance | |
| | test per ASTM 3330 Method F and No Change | | |
| | in Appearance | | |
| 5.7 | Cold temperature Pliability per ASTM D 1970 | No Cracking | |
| | Modified to −29° C. (−20° F.) No Cracking | | |
| 5.8 | Adhesion of Self Adhering Flashing After | 3.91 | lb/linear |
| | Water Immersion Peel Adhesion per AAMA | Inch | |
| | 800 Sec 2.4.1.3.1/2.4.1.4.3 ASTM D 3330, | | |
| | Method F Minimum Peel Value 0.26 N/mm | | |

| | | |
|---|---|---|
| 5.9 | Resistance to Peeling From Itself per AAA | No visual |
| | 711-07 | change in |
| | | appearance |
| | | or adhesion |

Accordingly, the self adhered flashing tape 500 provides a drainage plane employing a durable stand off for the exterior trim and cladding of the building envelope. The plane formed by the assembly of the self adhered flashing tape and the exterior materials, and the non directional nature of the standoff, create a drain and drying field when bonded to the most common building materials to allow the flow of air and water. The design or patterns allow water and air to flow in a nondirectional orientation through the gap formed by the facing surfaces of the first moisture impervious layer 510 and the construction material overlay. The present invention addresses the need for air to flow on the surface of the structure to remove moisture while creating an impermeable barrier film.

The standoff provided by flashing tape 500 is designed and materials of construction selected to withstand the pressure of nailed trim, cladding and other common exterior fabrications and assemblies. Further the selection of materials also meet industry needs to provide nail seal ability and a wide range of performance metrics well established in building sciences for pliability, bond strength, temperature conditions encountered in construction and the lifecycle of the structure.

Furthermore, the flashing tape 500 of the invention achieves a three level seal employing the LLDPE film, cross linked closed cellular foam and a high performance pressure sensitive adhesive material each with different rheology, density, elongation to break and other physical properties that when combined provide water hold out required by all published standards for self adhered flashing. Heat, mass, pressure and the shape of the embossing die are selected to achieve the desired shape. The design allows for the use of many types of adhesives although the preferred adhesives will provide a broad range of sealant compatibility as sealants are required and preferred for most window and door installations and will come into contact with the materials at critical building interfaces. With the invention and proliferation of so many new materials and surface finishes it is imperative that a design allows for multiple types of adhesive.

Compression molding of LLDPE layer 510 to the XLPE foam layer 520 forms the shapes of projections 511. The XLPE foam provides a flexible support mechanism forming and filling the underside of the stand off. Heat and mass are selected to achieve the shape out of a minimum of foam and film. The co-extrusion process allows for a thermal bond of the forming film 510 to the foam layer 520 where a non cross linked closed cell or open cell foam may collapse.

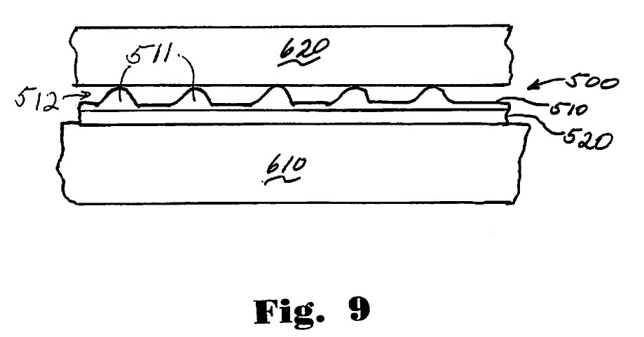

While the above description contains many specifics, these specifics should not be construed as limitations of the invention, but merely as exemplifications of preferred embodiments thereof. For example, the flashing tape of the invention can be used in any application in which it is advantageous to provide a barrier for moisture or an air flow and moisture drain field between two surfaces, such as automotive, commercial or other portions of residential and commercial construction, such as seaming tapes. For example, and referring now to FIG. 9, the flashing tape of the invention can be used to provide a horizontal drainage plane. The flashing tape 500 can be disposed over a subflooring 610 with the moisture impervious layer 510 as the top surface with the projections 511 pointing upward. A flooring, such as a wood flooring 620 is disposed over the flashing tape 500 such that the projections 511 act as spacers to provide a moisture and air flow path 512 between the moisture impervious layer 510 and the bottom surface of the flooring 620. The moisture impervious foam layer 520 can be in direct contact with the subflooring 610. The adhesive layer is optional, and in the embodiment shown in FIG. 9, is absent. In this embodiment the flashing tape 500 can be a material of any dimensions of length and width suitable for the purpose of flooring.

Those skilled in the art will envision many other embodiments within the scope and spirit of the invention as defined by the claims appended hereto.

What is claimed is:

1. A self adhered flashing tape for use in conjunction with an overlay of construction material, which comprises:
(a) a moisture-impervious nonporous first layer having a surface for providing air flow and drainage of moisture, said surface being textured with embossed or otherwise raised spaced apart projections, wherein said first layer is configured so that when an overlay of construction material is abutted against said surface a nondirectional flow path and capillary break is provided to permit the flow of air and water along said surface through a space between the construction material and the moisture impervious first layer;
(b) a layer of pressure sensitive adhesive associated with the moisture-impervious nonporous first layer, said adhesive possessing sufficient sealant compatibility as determined by the AAMA 713-08 Voluntary Test Method To Determine Chemical Compatibility Of Sealants And Self Adhered Flexible Flashings as well as meeting or exceeding performance requirements as determined by the AAMA 711-07 Voluntary Specification For Self Adhering Flashing Used For Installation Of Exterior Wall Fenestration Products.

2. The flashing tape of claim 1 further including a moisture-impervious second layer of cross-linked closed cell polymeric foam which is bonded on a first side to the moisture-impervious first layer, wherein the layer of pressure sensitive adhesive is applied to a second side of the moisture-impervious foam second layer.

3. The flashing tape of claim 2 wherein the moisture-impervious first layer is fabricated from polyethylene and the moisture-impervious second layer is fabricated from polyethylene.

4. The flashing tape of claim 2 wherein the moisture-impervious first layer and the moisture-impervious second layer of closed cell polymeric material are directly joined by co-extrusion or flame bonding.

5. The flashing tape of claim 2 wherein the moisture-impervious first layer and the moisture-impervious second layer of closed cell polymeric foam are fabricated from substantially the same polymer and are directly joined by co-extrusion to provide an integral structure.

6. The flashing tape of claim 1 wherein the adhesive comprises an acrylic based adhesive.

7. The flashing tape of claim 1 including a release liner removably disposed over the layer (b) of adhesive.

8. The flashing tape of claim 1 wherein the drainage plane surface provides a drainage rate of at least 32 oz. per hour per inch of width of the flashing tape.

9. The flashing tape of claim 1 further including one or more additive selected from plasticizers, colorants, fillers, UV agents, mold and mildew inhibitors , insecticides and flame retardants.

10. The flashing tape of claim 1 wherein the projections have a height of at least 0.009 inches.

11. The flashing tape of claim 10 wherein the projections are spaced apart by a distance of at least about 0.02 inches.

12. The flashing tape of claim 1 wherein the construction material overlay comprises trim, siding or cladding.

13. A method for sealing a joint in a wall of a building comprising:
a) attaching to a surface of the wall over or in the vicinity of the joint a flashing tape which includes,
(i)) a moisture-impervious nonporous first layer having a surface for providing air flow and drainage of moisture, said surface being textured with embossed or otherwise raised spaced apart projections, wherein said first layer is configured so that when an overlay of construction material is abutted against said surface a nondirectional flow path and capillary break is provided to permit the flow of air and water along said surface through a space between the construction material and the moisture impervious first layer;
(ii) a layer of pressure sensitive adhesive associated with the moisture-impervious nonporous first layer, said adhesive possessing sufficient sealant compatibility as determined by the AAMA 713-08 Voluntary Test Method To Determine Chemical Compatibility Of Sealants And Self Adhered Flexible Flashings as well as meeting or exceeding performance requirements as determined by the AAMA 711-07 Voluntary Specification For Self Adhereing Flashing Used For Installation Of Exterior Wall Fenestration Products; and,
b) applying an overlay of construction material over the flashing tape.

14. The method of claim 13 wherein the flashing tape further includes a moisture-impervious second layer of cross-linked closed cell polymeric foam which is bonded on a first side to the moisture-impervious first layer, wherein the layer of pressure sensitive adhesive is applied to a second side of the moisture-impervious foam second layer.

15. The method of claim 14 wherein the moisture-impervious first layer and moisture-impervious second layer are fabricated of the same polymeric material and are thermally bonded together by co-extrusion or flame bonding.

16. The method of claim 15 wherein the moisture-impervious film and the water-impervious layer of closed cell polymeric foam are both fabricated from polyethylene.

17. The method of claim 14 wherein the moisture-impervious first layer and moisture-impervious second layer are adhesively bonded.

18. The method of claim 13 wherein the flashing tape includes a release liner and said method comprises removing said release liner prior to attaching the flashing tape to the surface of the wall.

19. The method of claim 18 wherein the release liner is fabricated from a recyclable material and is recycled after removal.

20. The method of claim 13 wherein the joint is between a portal and an edge of the wall defining an opening configured and dimensioned to receive the portal.

21. The method of claim 13 wherein the construction material includes a siding or cladding member onto the flashing tape with fasteners, wherein the flashing tape exhibits no significant water penetration around said fasteners as measured by ASTM D 1970-01 Sec. 7.9.

22. A method of providing a nondirectional flow path for the drainage of moisture and/or air between two construction surfaces comprising:
a) attaching to a first construction surface a flashing material which includes,
(i) a moisture-impervious nonporous first layer having a surface for providing air flow and drainage of moisture, said surface being textured with embossed or otherwise raised spaced apart projections, wherein said first layer is configured so that when an overlay of construction material is abutted against said surface a nondirectional flow path and capillary break is provided to permit the flow of air and water along said surface through a space between the construction material and the moisture impervious first layer;
(ii) a moisture-impervious second layer of closed cell polymeric foam which is bonded on a first side to the moisture-impervious first layer; and,
b) applying an overlay of a second construction surface over the flashing material.

23. The method of claim 22 wherein the first construction surface is a subflooring and the second construction surface is a flooring.

24. The method of claim 22 wherein the flashing material further includes a layer of pressure sensitive adhesive applied to a second side of the moisture-impervious layer, said adhesive possessing sufficient sealant compatibility as determined by the AAMA 713-08 Voluntary Test Method To Determine Chemical Compatibility Of Sealants And Self Adhered Flexible Flashings and meets or exceeds the performance and test requirements of AAMA 711-07 Voluntary Specification for Self Adhering Flashing Used for Installation of Exterior Wall Fenestration Products
